(19) United States
(12) Patent Application Publication
(10) Pub. No.: US 2025/0048246 A1
(43) Pub. Date: Feb. 6, 2025

(54) UE, ACCESS NETWORK NODE, AND METHOD

(71) Applicant: NEC CORPORATION, Minato-ku, Tokyo (JP)

(72) Inventor: Yuhua CHEN, London (GB)

(73) Assignee: NEC CORPORATION, Minato-ku, Tokyo (JP)

(21) Appl. No.: 18/718,101

(22) PCT Filed: Dec. 2, 2022
(86) PCT No.: PCT/JP2022/044639

§ 371 Date: Jun. 10, 2024

(30) Foreign Application Priority Data
Dec. 22, 2021 (GB) 2118814.9

(51) Int. Cl. H04W 48/20; H04W 60/04; H04W 84/06

(52) U.S. Cl. CPC H04W 48/20; H04W 60/04; H04W 84/06

(57) ABSTRACT

A communication system is disclosed in which a user equipment (UE) receives an indication that a change of tracking area identifiers has occurred with respect to a current cell of the UE. The UE determines whether to obtain a tracking area identifier list associated with the cell based on the indication and at least one of: information identifying whether the cell is configurable to associate with a plurality of tracking areas (e.g. when the cell employs soft tracking area change); a mobility parameter associated with the UE; and a time parameter indicating a time elapsed since the UE obtained the tracking area identifier list from system information signalling or since the UE reselected to the cell.

### TECHNICAL FIELD

The present disclosure relates to a wireless communication system and devices thereof operating according to the 3rd Generation Partnership Project (3GPP) standards or equivalents or derivatives thereof. The disclosure has particular but not exclusive relevance to improvements relating to tracking area update in the so-called ‘5G’ (or ‘Next Generation’) systems employing a non-terrestrial portion comprising airborne or spaceborne network nodes.

### BACKGROUND ART

Under the 3GPP standards, a NodeB (or an ‘eNB’ in LTE, ‘gNB’ in 5G) is a base station via which communication devices (user equipment or ‘UE’) connect to a core network and communicate to other communication devices or remote servers. Communication devices might be, for example, mobile communication devices such as mobile telephones, smartphones, smart watches, personal digital assistants, laptop/tablet computers, web browsers, e-book readers, and/or the like. Such mobile (or even generally stationary) devices are typically operated by a user (and hence they are often collectively referred to as user equipment, ‘UE’) although it is also possible to connect Internet of Things (IoT) devices and similar machine-type communication (MTC) devices to the network. For simplicity, the present application will use the term base station to refer to any such base stations and use the term mobile device or UE to refer to any such communication device.

The latest developments of the 3GPP standards are the so-called ‘5G’ or ‘New Radio’ (NR) standards which refer to an evolving communication technology that is expected to support a variety of applications and services such as MTC, IoT/Industrial IoT (IIoT) communications, vehicular communications and autonomous cars, high resolution video streaming, smart city services, and/or the like. 3GPP intends to support 5G by way of the so-called 3GPP Next Generation (NextGen) radio access network (RAN) and the 3GPP NextGen core (NGC) network. Various details of 5G networks are described in, for example, the ‘NGMN 5G White Paper’ V1.0 by the Next Generation Mobile Networks (NGMN) Alliance, which document is available from https://www.ngmn.org/5g-white-paper.html.

End-user communication devices are commonly referred to as User Equipment (UE) which may be operated by a human or comprise automated (MTC/IoT) devices. Whilst a base station of a 5G/NR communication system is commonly referred to as a New Radio Base Station (‘NR-BS’) or as a ‘gNB’ it will be appreciated that they may be referred to using the term ‘eNB’ (or 5G/NR eNB) which is more typically associated with Long Term Evolution (LTE) base stations (also commonly referred to as ‘4G’ base stations). 3GPP Technical Specification (TS) 38.300 V16.4.0 and TS 37.340 V16.4.0 define the following nodes, amongst others:

gNB: node providing NR user plane and control plane protocol terminations towards the UE, and connected via the NG interface to the 5G core network (5GC).

ng-eNB: node providing Evolved Universal Terrestrial Radio Access (E-UTRA) user plane and control plane protocol terminations towards the UE, and connected via the NG interface to the 5GC.

En-gNB: node providing NR user plane and control plane protocol terminations towards the UE, and acting as Secondary Node in E-UTRA-NR Dual Connectivity (EN-DC).

NG-RAN node: either a gNB or an ng-eNB.

3GPP is also working on specifying an integrated satellite and terrestrial network infrastructure in the context of 5G. The term Non-Terrestrial Networks (NTN) refers to networks, or segments of networks, that are using an airborne or spaceborne vehicle for transmission. Satellites refer to spaceborne vehicles in Geostationary Earth Orbit (GEO) or in Non-Geostationary Earth Orbit (NGEO) such as Low Earth Orbits (LEO), Medium Earth Orbits (MEO), and Highly Elliptical Orbits (HEO). Airborne vehicles refer to High Altitude Platforms (HAPs) encompassing Unmanned Aircraft Systems (UAS)—including tethered UAS, Lighter than Air UAS and Heavier than Air UAS-all operating quasi-stationary at an altitude typically between 8 and 50 km.

NPL 1 is a study on New Radio to support such Non-Terrestrial Networks. The study includes, amongst others, NTN deployment scenarios and related system parameters (such as architecture, altitude, orbit etc.) and a description of adaptation of 3GPP channel models for Non-Terrestrial Networks (propagation conditions, mobility, etc.). NPL 2 provides further details about NTN.

Non-Terrestrial Networks are expected to:
help foster the 5G service roll out in un-served or underserved areas to upgrade the performance of terrestrial networks;
reinforce service reliability by providing service continuity for user equipment or for moving platforms (e.g. passenger vehicles-aircraft, ships, high speed trains, buses);
increase service availability everywhere: especially for critical communications, future railway/maritime/aeronautical communications; and
enable 5G network scalability through the provision of efficient multicast/broadcast resources for data delivery towards the network edges or even directly to the user equipment.

NTN access typically features the following elements (amongst others):
NTN Terminal: It may refer to a 3GPP UE or a terminal specific to the satellite system in case the satellite doesn't serve directly 3GPP UEs.
A service link which refer to the radio link between the user equipment and the space/airborne platform (which may be in addition to a radio link with a terrestrial based RAN).
A space or an airborne platform.
Gateways (‘NTN Gateways’) that connect the satellite or aerial access network to the core network. It will be appreciated that gateways will mostly likely be co-located with a base station.
Feeder links which refer to the radio links between the gateways and the space/airborne platform.

Satellite or aerial vehicles may generate several beams over a given area to provide respective NTN cells. The beams have a typically elliptic footprint on the surface of the Earth.

3GPP intends to support three types of NTN beams or cells:
Earth-fixed cells characterized by beam(s) covering the same geographical areas all the time (e.g. GEO satellites and HAPS);
quasi-Earth-fixed cells characterized by beam(s) covering one geographic area for a finite period and a different geographic area during another period (e.g.

NGEO satellites generating steerable beams); and
Earth-moving cells characterized by beam(s) covering one geographic area at one instant and a different geographic area at another instant (e.g. NGEO satellites generating fixed or non-steerable beams).

With satellite or aerial vehicle keeping position fixed in terms of elevation/azimuth with respect to a given earth point e.g. GEO and UAS, the beam footprint is earth fixed.

With satellite circulating around the earth (e.g. LEO) or on an elliptical orbit around the earth (e.g. HEO) the beam footprint may be moving over the Earth with the satellite or aerial vehicle motion on its orbit. Alternatively, the beam footprint may be Earth-fixed (or quasi-Earth-fixed) temporarily, in which case an appropriate beam pointing mechanism (mechanical or electronic steering) may be used to compensate for the satellite or aerial vehicle motion.

In 5G/NR, each cell has an associated ‘NR Cell Global Identifier’ (NCGI) which is constructed from the Public Land Mobile Network (PLMN) identity (PLMN ID) the cell belongs to and the NR Cell Identity (NCI) of the cell. It will be appreciated that similar identifiers may be used in other systems as well, as appropriate.

In terrestrial networks, groups of cells are allocated to different tracking areas which may correspond to respective geographical areas (such as a district, a city, a region, or any similar geographical unit). Each tracking area has an associated identifier referred to as the tracking area code (TAC) or tracking area identifier (TAI). In some systems, a tracking area may be referred to as a location area. With relatively small cell size, and fixed cell coverage in terrestrial networks, a cell usually broadcasts only one TAC per PLMN. A registration area (called a routing area in some systems) is a list of tracking areas (i.e. one or multiple TAC) that a UE has registered with the core network where the UE can be found for any incoming (mobile terminated) communication by paging. Registration of such tracking areas (TACs) is performed via an appropriate Non-Access Stratum (NAS) procedure such as an Attach procedure or a Registration Area Update procedure. The UE is expected to perform a Registration Area Update (triggered by mobility) if the UE moves out of the UE's current registration area. This is determined based on the TAC(s), i.e. a list of tracking area codes/identifiers, being broadcast in the cell on which the UE is camping. Specifically, if none of the TACs broadcast in a cell belong to the UE's current registration area, then the UE will perform Registration Area Update.

### CITATION LIST

### Non Patent Literature

NPL 1: 3GPP Technical Report (TR) 38.811 V15.4.0
NPL 2: 3GPP TR 38.821 V16.1.0

### SUMMARY OF INVENTION

### Technical Problem

3GPP is still working on the detailed specifications for non-terrestrial networks, however, it is assumed that Earth fixed tracking areas will be still used with Earth fixed cells and/or moving cells. In other words, Tracking Area Codes in NTN are fixed to respective geographical locations (or areas) on Earth. It will be appreciated that an ‘Earth fixed tracking area’ is more likely to be a quasi fixed tracking area in practice due to the movement of the non-terrestrial cells. Each tracking area has an associated identifier referred to as the tracking area code (TAC) or tracking area identifier (TAI).

Due to their relatively large and/or moving cell coverage, the network may broadcast multiple TACs in NR NTN cells, including multiple TACs for the same PLMN or different PLMNs. Moreover, a TAC change in System Information may happen when the cell coverage moves in or out of a tracking area. This is under network control, and it may not be exactly synchronised with real-time illumination of beams on the ground. When a UE moves from one tracking area to another, it may be expected to perform a RAU procedure to tell the network where the UE can be found for any incoming (mobile terminated) communication if none of the broadcasted TACs belong to the UE's current registration area. However, the UE is not expected to perform a RAU procedure triggered by mobility if one of the currently broadcasted TACs belongs to the UE's registration area.

In non-terrestrial networks, the network may broadcast more than one TAC per PLMN in a cell, which is to up to network implementation. However, when the network stops broadcasting a particular TAC for a cell, UEs in that cell (and/or neighbouring cells) need to be made aware of this change. 3GPP RAN2 work group assumes that a UE will not perform RAU if one of the currently broadcasted TAC belongs to the UE's registration area. In non-terrestrial networks, the timing of TAC change is up to network implementation (by changing the system information associated with the cell). Thus, the TAC change may not exactly be synchronous with real-time cell changes experienced by the UEs on the ground. Each cell indicates its associated TAC(s) in system information block type 1 (‘SIB1’). A change in TAC triggers a system information update notification procedure (e.g. when a particular NTN cell moves into a geographical area that belongs to a different tracking area than the ones currently associated with that cell). It is for further study whether broadcasting of TAC update time will be employed.

In case of IoT devices, in the context of non-terrestrial networks, the same general approach applies. However, for these devices, there is no agreement yet on how to inform these devices about a TAC change. The existing system information update notification procedure is not expected to be applicable to IoT devices to inform them about TAC updates (at least for TAC additions). Moreover, there is no agreement yet whether NTN cells will use a soft TAC change or a hard TAC change (it is currently up to network implementation). In case of soft TAC change, an NTN cell broadcasts the TACs for any overlapping terrestrial cell (e.g. when the NTN cell already covers a new tracking area on the ground, at least partially, and the cell still covers a part of the previous tracking area, the TACs for both tracking areas are broadcast by the NTN cell). In the case of hard TAC change, the NTN cell broadcasts a single TAC (per PLMN), for example, the TAC corresponding to a newly entered tacking area on the ground (even when the NTN cell still covers a part of the previous tracking area). The difference between soft and hard TAC change is illustrated in FIG. 2.

3GPP is discussing various solutions for ensuring UEs served by (or camping on) an NTN cell have up-to-date information regarding the tracking area(s) to which that cell belongs. The most promising solution is to provide a validity timer for each TAC broadcast in the system information. The UE uses the associated validity timer of the TACs to select a tracking area and to perform TAU using the TAC of that tracking area. The validity timer of a TAC can be given using 16 bits of information with a timing accuracy of +/−100 ms.

In another proposal, a short message is used when an NTN cell stops broadcasting a TAC. If (any part of) the system information changes, the network will page all UEs in the affected area. In this case, idle UEs monitor for system information change indication in their own paging occasion, as defined based on their associated discontinuous reception (DRX) cycle. If a system information change indication is included in the paging message, the UE performs the system information acquisition procedure at the nearest modification period boundary, as known in the art. Paging frequency due to TAC change in system information depends on various factors such as TAC list planning, cell size, and moving speed of the satellites. However, it is a complex issue and it may result in a relatively large signalling overhead to provide a valid timer related to each TAC, especially in the case when the network continues broadcasting those TACs which are not covered by current cell (which may be necessary in order to avoid some UEs becoming unreachable). Apart from the signalling overhead, this approach may also result in the UE being unable to determine, based on the validity timer alone, which TAC should be reported in the TAU procedure.

When soft TAC update is used, it is not clear whether the TAC update will trigger system information update notification or not. One contribution proposed that system information update notification is needed because the UE which might have crossed the tracking area will not detect its mobility across tracking areas (if the UE is not informed about the addition or removal of a tracking area via system information) and the UE will not trigger a registration area update. This may lead to the UE missing any paging from the (core) network as the current tracking area is not known to the network. Another contribution argues that due to the speed of the satellites a cell may enter/add a new tracking area every 67 seconds which would cause frequent tracking area updates and increased power consumption for the UEs if the existing system information modification procedure is used. Moreover, UEs configured with extended DRX may be able to acquire system information once in every 4 hours. Thus, system information update notification is not useful for these UEs either.

However, the inventor has realised that in some scenarios it may be impossible to reach a particular UE if the UE is not aware of the TAC change (and has not performed a RAU) whilst camping on an NTN cell which has entered a new tracking area. Specifically, if a UE remains registered with a TAC that has been removed from a cell in a recent system information update, and the UE (e.g. UE/IoT device configured with DRX or eDRX) has not received a notification or a paging message indicating this change, the UE may become unreachable since the UE's current (NTN) cell no longer belongs to any of the UE's currently registered tracking areas. This problem may affect those UEs in particular that are moving in the same direction as the NTN cell since they remain in that cell's coverage relatively longer than other UEs but enter a new tracking area sooner. In summary, when system information update notification is provided for TAC change (e.g. removal), for most UEs it is unnecessary to perform system information acquisition since they would still be reachable using the TAC known to the core network (unless this is a TAC that has been removed). On the other hand, when system information update notification is not provided for a TAC change (e.g. removal) or when it is not received by a UE (moving in the same direction as the satellite), the UE may not perform a RAU in a timely manner when it relies on a validity timer or similar means since the UE may have left the tracking area known to the core network before its TAC has been removed from the cell system information.

Accordingly, the present disclosure seeks to provide methods and associated apparatus that address or at least alleviate (at least some of) the above described issues.

### Solution to Problem

Although for efficiency of understanding for those of skill in the art, the present disclosure will be described in detail in the context of a 3GPP system (5G networks including NTN), the principles of the present disclosure can be applied to other systems as well.

In one aspect, the present disclosure provides a method performed by a user equipment (UE) in a system comprising a plurality of cells, the method comprising: receiving an indication that a change of tracking area identifiers has occurred with respect to a current cell of the UE; and determining whether to obtain a tracking area identifier list associated with the cell based on the indication and at least one of: information identifying whether the cell is configurable to associate with a plurality of tracking areas: a mobility parameter associated with the UE; and a time parameter indicating a time elapsed since the UE obtained the tracking area identifier list from system information signalling or since the UE reselected to the cell.

In one aspect, the present disclosure provides a method performed by an access network node in a system comprising a plurality of cells, the method comprising: transmitting system information signalling including a tracking area identifier list associated with a cell of the access network node, wherein the tracking area identifier list includes at least one tracking area identifier: updating the tracking area list wherein the updating comprises at least one of: tracking area identifier addition: tracking area identifier removal; and tracking area identifier change concerning the at least one tracking area identifier; and transmitting an indication that the tracking area identifier list has been updated: wherein the indication is adapted to be used in determining, by at least one user equipment (UE), whether to obtain the tracking area identifier list from further system information signalling transmitted by the access network node, and the determining is based on at least one of: whether the cell is configurable to associate with a plurality of tracking areas: a mobility parameter associated with the UE; and a time parameter indicating a time elapsed since the UE obtained the tracking area identifier list from the system information signalling or since the UE reselected to the cell.

In one aspect, the present disclosure provides a method performed by a user equipment (UE), the method comprising: obtaining, for a current cell of the UE, information identifying a time threshold relating to the cell; and obtaining the tracking area identifier list broadcast in the cell in a case that a time elapsed since the UE obtained the tracking area identifier list is greater than the time threshold.

In one aspect, the present disclosure provides a method performed by a user equipment (UE), the method comprising: obtaining, for a current cell of the UE, information identifying a time parameter for determining a time point for obtaining a tracking area identifier list for the cell: obtaining the tracking area identifier list broadcast in the cell at the time point.

In one aspect, the present disclosure provides a method performed by a user equipment (UE), the method comprising: registering a tracking area identifier list with a network node based on at least one condition: wherein the at least one condition includes one or more of: a condition that the current cell is a non-terrestrial cell: a condition that the current cell is an earth-moving cell: a condition that the UE is moving in substantially the same direction as the current cell: a condition that the current cell is configurable to associate with a plurality of tracking areas: a condition that a distance travelled by the UE since the registering the first identifier with the network node is greater than an associated distance threshold; and a condition that a time elapsed since the registering the first identifier with the network node is greater than an associated time threshold.

In one aspect, the present disclosure provides a method performed by a user equipment (UE), the method comprising: obtaining, for a current cell of the UE, information identifying a cell specific period for triggering a registration area update procedure; and triggering registration area update procedure, in the cell, based on the period.

In one aspect, the present disclosure provides a method performed by a network node for handling connection and mobility management for a user equipment (UE), the method comprising: maintaining a registration area associated with the UE, the registration area comprising a set of tracking area identifiers for use in transmitting a paging message for the UE, the set including a first tracking area identifier; and transmitting, via a first cell, a paging message towards the UE in a case that the first tracking area identifier has been removed from a tracking area identifier list associated with the first cell.

In one aspect, the present disclosure provides a user equipment (UE) in a system comprising a plurality of cells, the UE comprising: means (for example a memory, a transceiver, and a processor) for receiving an indication that a change of tracking area identifiers has occurred with respect to a current cell of the UE; and means for determining whether to obtain a tracking area identifier list associated with the cell based on the indication and at least one of: information identifying whether the cell is configurable to associate with a plurality of tracking areas: a mobility parameter associated with the UE; and a time parameter indicating a time elapsed since the UE obtained the tracking area identifier list from system information signalling or since the UE reselected to the cell.

In one aspect, the present disclosure provides an access network node in a system comprising a plurality of cells, the access network node comprising: means (for example a memory, a transceiver, and a processor) for transmitting system information signalling including a tracking area identifier list associated with a cell of the access network node, wherein the tracking area identifier list includes at least one tracking area identifier: means for updating the tracking area list wherein the updating comprises at least one of: tracking area identifier addition: tracking area identifier removal; and tracking area identifier change concerning the at least one tracking area identifier; and means for transmitting an indication that the tracking area identifier list has been updated: wherein the indication is adapted to be used in determining, by at least one user equipment (UE), whether to obtain the tracking area identifier list from further system information signalling transmitted by the access network node, and the determining is based on at least one of: whether the cell is configurable to associate with a plurality of tracking areas: a mobility parameter associated with the UE; and a time parameter indicating a time elapsed since the UE obtained the tracking area identifier list from the system information signalling or since the UE reselected to the cell.

In one aspect, the present disclosure provides a user equipment (UE) comprising: means (for example a memory, a transceiver, and a processor) for obtaining, for a current cell of the UE, information identifying a time threshold relating to the cell; and means for obtaining the tracking area identifier list broadcast in the cell in a case that a time elapsed since the UE obtained the tracking area identifier list is greater than the time threshold.

In one aspect, the provides a user equipment (UE) comprising: means (for example a memory, a transceiver, and a processor) for obtaining, for a current cell of the UE, information identifying a time parameter for determining a time point for obtaining a tracking area identifier list for the cell: means for obtaining the tracking area identifier list broadcast in the cell at the time point.

In one aspect, the present disclosure provides a user equipment (UE) comprising: means (for example a memory, a transceiver, and a processor) for registering a tracking area identifier list with a network node based on at least one condition; wherein the at least one condition includes one or more of: a condition that the current cell is a non-terrestrial cell; a condition that the current cell is an earth-moving cell: a condition that the UE is moving in substantially the same direction as the current cell: a condition that the current cell is configurable to associate with a plurality of tracking areas: a condition that a distance travelled by the UE since the registering the first identifier with the network node is greater than an associated distance threshold; and a condition that a time elapsed since the registering the first identifier with the network node is greater than an associated time threshold.

In one aspect, the present disclosure provides a user equipment (UE) comprising: means (for example a memory, a transceiver, and a processor) for obtaining, for a current cell of the UE, information identifying a cell specific period for triggering a registration area update procedure; and means for triggering registration area update procedure, in the cell, based on the period.

In one aspect, the present disclosure provides a network node for handling connection and mobility management for a user equipment (UE), the network node comprising: means (for example a memory, a transceiver, and a processor) for maintaining a registration area associated with the UE, the registration area comprising a set of tracking area identifiers for use in transmitting a paging message for the UE, the set including a first tracking area identifier; and means for transmitting, via a first cell, a paging message towards the UE in a case that the first tracking area identifier has been removed from a tracking area identifier list associated with the first cell.

Aspects of the present disclosure extend to corresponding systems, apparatus, and computer program products such as computer readable storage media having instructions stored thereon which are operable to program a programmable processor to carry out a method as described in the aspects and possibilities set out above or recited in the claims and/or to program a suitably adapted computer to provide the apparatus recited in any of the claims.

Each feature disclosed in this specification (which term includes the claims) and/or shown in the drawings may be incorporated in the present disclosure independently of (or in combination with) any other disclosed and/or illustrated features. In particular but without limitation the features of any of the claims dependent from a particular independent claim may be introduced into that independent claim in any combination or individually.

### BRIEF DESCRIPTION OF DRAWINGS

Example embodiments of the present disclosure will now be described, by way of example, with reference to the accompanying drawings in which:

FIG. 1 illustrates schematically a mobile (cellular or wireless) telecommunication system to which example embodiments of the present disclosure may be applied;

FIG. 2 illustrates schematically the difference between soft and hard tracking area code update in the system shown in FIG. 1:

FIG. 3 illustrates schematically some exemplary mobility scenarios to which example embodiments of the present disclosure may be applied:

FIG. 4 is a schematic block diagram of a mobile device forming part of the system shown in FIG. 1:

FIG. 5 is a schematic block diagram of an NTN node (e.g. satellite/UAS platform) forming part of the system shown in FIG. 1:

FIG. 6 is a schematic block diagram of an access network node (e.g. base station) forming part of the system shown in FIG. 1; and

FIG. 7 illustrates schematically some exemplary architecture options for the provision of NTN features in the system shown in FIG. 1.

### DESCRIPTION OF EMBODIMENTS

### Overview

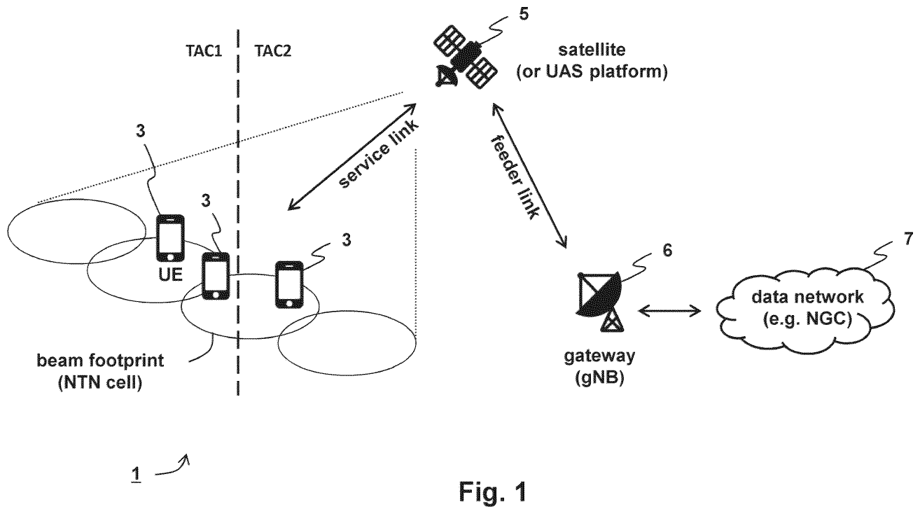

FIG. 1 illustrates schematically a mobile (cellular or wireless) telecommunication system 1 to which example embodiments of the present disclosure may be applied. In this system 1, users of mobile devices 3 (UEs) can communicate with each other and other users via access network nodes respective satellites 5 and/or base stations 6 and a data network 7 using an appropriate 3GPP radio access technology (RAT), for example, an E-UTRA and/or 5G RAT. As those skilled in the art will appreciate, whilst three mobile devices 3, one satellite 5, and one base station 6 are shown in FIG. 1 for illustration purposes, the system, when implemented, will typically include other satellites/UAS platforms, base stations/RAN nodes, and mobile devices (UEs).

It will be appreciated that a number of base stations 6 form a (radio) access network or (R)AN, and a number of NTN nodes 5 (satellites and/or UAS platforms) form a Non-Terrestrial Network (NTN). Each NTN node 5 is connected to an appropriate gateway (in this case co-located with a base station 6) using a so-called feeder link and connected to respective UEs 3 via corresponding service links. Thus, when served by an NTN node 5, a mobile device 3 communicates data to and from a base station 6 via the NTN node 5, using an appropriate service link (between the mobile device 3 and the NTN node 5) and a feeder link (between the NTN node 5 and the gateway/base station 6). In other words, the NTN forms part of the (R)AN, although it may also provide satellite communication services independently of E-UTRA and/or 5G communication services.

Although not shown in FIG. 1, neighbouring base stations 6 are connected to each other via an appropriate base station to base station interface (such as the so-called ‘X2’ interface, ‘Xn’ interface and/or the like). The base station 6 is also connected to the data network nodes via an appropriate interface (such as the so-called ‘S1’, ‘NG-C’, ‘NG-U’ interface, and/or the like).

The data (or core) network 7 (e.g. the EPC in case of LTE or the NGC in case of NR/5G) typically includes logical nodes (or ‘functions’) for supporting communication in the telecommunication system 1, and for subscriber management, mobility management, charging, security, call/session management (amongst others). For example, the data network 7 of a ‘Next Generation’/5G system will include user plane entities and control plane entities, such as one or more control plane functions (CPFs) and one or more user plane functions (UPFs). The data network 7 is also coupled to other data networks such as the Internet or similar Internet Protocol (IP) based networks (not shown in FIG. 1).

Each cell has an associated ‘NR Cell Global Identifier’ which is constructed from the PLMN identity (PLMN ID) the cell belongs to and the NR Cell Identity (NCI) of the cell.

Each NTN node 5 controls a number of directional beams via which associated NTN cells may be provided. Specifically, each beam has an associated footprint on the surface of the Earth which corresponds to an NTN cell. Each NTN cell (beam) has an associated Physical Cell Identity (PCI) and/or beam identity. The beam footprints may be moving as the NTN node 5 is travelling along its orbit. Alternatively, the beam footprint may be earth fixed, in which case an appropriate beam pointing mechanism (mechanical or electronic steering) may be used to compensate for the movement of the NTN node 5.

Each cell is associated with at least one tracking area which is identified based on its TAC (or TAI).

In case of terrestrial cells, the tracking area(s) to which the cell is assigned is substantially fixed (unless the tracking areas are reconfigured e.g. for network optimisation reasons and/or the like). The system information (specifically, SIB1) indicates the TAC(s) associated with a particular cell. The system information may also include information indicating the validity of each TAC associated with the cell (e.g. an associated validity timer), although this may not be necessary for terrestrial cells.

In case of non-terrestrial cells, the tracking area(s) assigned to the cell depend on which terrestrial cell and which associated tracking area is covered by the footprint of the NTN cell on the ground. Thus, in time, the TAC(s) associated with a particular NTN cell will change as the footprint of the NTN cell moves from one geographical area/different tracking area to another.

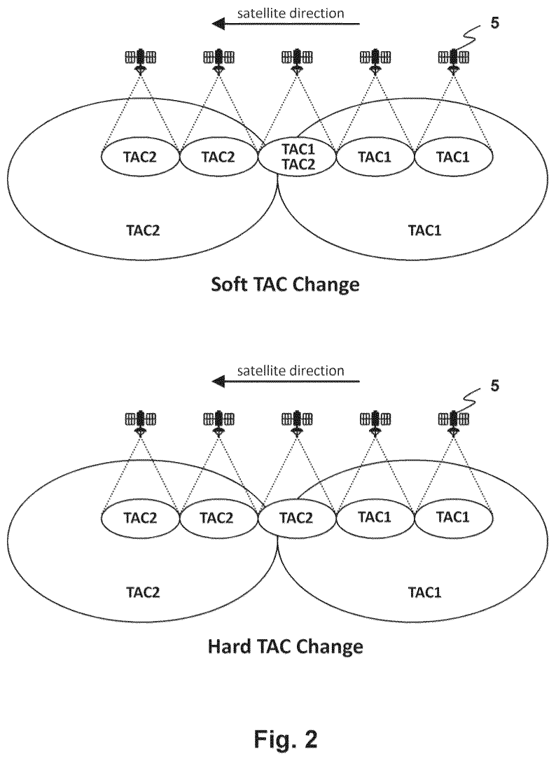

There are two approaches to select and update the appropriate TAC(s) broadcasted in system information for an NTN cell, referred to as soft TAC change and hard TAC change, respectively. The difference between soft and hard TAC change is illustrated in FIG. 2.

When soft TAC change is employed by the system, each NTN cell broadcasts the TAC for any terrestrial cell overlapping with the footprint of the NTN cell. Thus, as can be seen in the top half of FIG. 2, when the NTN cell starts to cover a new tracking area on the ground, at least partially, the TAC (TAC2 in this example) corresponding to that tracking area is added to the list of TACs broadcast by the NTN cell. However, as long as the NTN cell still covers a part of the previous tracking area, the TAC for the previous tracking area (TAC1 in this example) is not removed from the system information. Thus, in the middle position, when the NTN cell footprint transitions from one tracking area to the next, the NTN cell broadcasts the TAC for both tracking areas (TAC1 and TAC2 in this example).

When hard TAC change is employed by the system, each NTN cell broadcasts a single TAC (per PLMN). Typically, the TAC broadcast by the NTN cell is the TAC of the most recently entered tacking area on the ground. In the example shown in the bottom half of FIG. 2, as soon as the footprint of the NTN cell falls into a new tracking area on the ground (in this case TAC2), even partially, the TAC of any previously covered tracking area is removed from the system information. Thus, in the middle position, when the NTN cell footprint transitions from one tracking area to the next, the NTN cell switches to broadcasting TAC2 instead of TAC1 (even though the cell footprint still partially overlaps with the tracking area with TAC1).

Regardless of whether soft or hard TAC change is used, whenever there is a change (at least removal) of a TAC being broadcast in a cell, an appropriate system information update notification procedure is triggered by the base station 6/NTN node 5 in order to notify the UEs 3 about the change. Whilst such changes are relatively rare in case of terrestrial cells, they may occur relatively frequently in case of NTN cells due to movement of the satellites 5. In any case, since system information update notification can only be performed at given intervals, the indication of a TAC change via this approach may not exactly be synchronous with real-time cell changes experienced by the UEs 3 on the ground.

In order to notify UEs 3 about a system information update and to provide the updated system information, the concept of a modification period is used. Specifically, if there is a change in system information (e.g. change of TAC) then the base station 6/NTN node 5 first transmits an indication (‘SI change indication’) in one modification period, and the actual updated system information message is broadcasted in the next modification period. The indications about system information modifications may also be sent using appropriate paging messages to the concerned UEs 3.

Based on the indication/paging message, each UE 3 determines whether or not it needs to acquire the updated system information in the next modification period. If a UE 3 acquires the updated system information, based on the TAC(s) in the updated system information for their current cell, the UE 3 also determines whether it needs to perform a registration area update (RAU). In general, when the TAC (or TACs) indicated in the updated system information does not match the UE's current registration area (i.e. the TAC list reported/configured in the last RAU procedure), the UE 3 proceeds to perform RAU, using the updated TAC (or TACs) broadcast in the UE's current cell. If at least one TAC in the updated system information matches the UE's registration area, no RAU is necessary (unless there are other reasons to perform RAU, such as expiry of an associated timer).

In this system 1, when a UE 3 is served via the non-terrestrial portion of the access network the UE 3 is configured to follow specific procedures to determine whether RAU is necessary upon system information/TAC change. Specifically, the UE 3 is configured to employ one of the following options:

Option 1: When the UE 3 receives a system information update notification or paging message (if applicable) for TAC change/addition/removal, the UE 3 decides whether or not to acquire the updated system information (and any TAC included therein) based on specific conditions. The system information update notification or paging message may be adapted to indicate that the reason for the system information update is to provide a TAC change/addition/removal. This may be indicated using an appropriate flag or using 1-bit of information. In case that the system information update is for a TAC change/addition/removal, the UE 3 does not need to acquire the updated TACs in system information in a cell that employs soft TAC change (because soft TAC change does not remove the old TAC immediately upon adding a new TAC), especially in case of UEs 3 with low mobility, UEs 3 moving in the opposite direction as the cell moving direction, and/or UEs 3 that have performed cell reselection to this cell within a certain amount of time. Otherwise, system information acquisition may be performed, for example, if a certain amount of time has passed since the last cell reselection or last tracking area information reading by the UE 3 (determined e.g. based on an associated timer) and/or based on mobility of the UE 3 (e.g. if the UE 3 is moving in substantially the same direction as the cell: if the distance from the UE's 3 position at the last reading of the tracking area information to the UE's current location is over an associated threshold (at least in one direction): if the distance from a centre of the cell footprint is over an associated threshold (at least in one direction); and/or if the speed of the UE 3 is higher than an associated threshold).

Option 2: The UE 3 is configured to read TAC information automatically when certain conditions are met (regardless whether the UE 3 has received any system information update notification or paging message). In a first possibility, the UE 3 may receive (e.g. in system information) information identifying an appropriate timer (herein referred to as ‘timer T_{TAC1}’) or information identifying one or more points in time (herein referred to as ‘TAC check-up points’) for determining whether the UE 3 should read the TAC of its cell. For example, the UE 3 may be configured to read the TAC upon expiry of the time T_{TAC1} and/or upon reaching one of the check-up points associated with its cell. It will be appreciated that the system information/TAC acquisition may be dependent on cell specific factors as well, such as the diameter of the cell and/or the speed of the cell. Effectively, a time value (for an additional timer e.g. T_{TAC2}) may be derived by dividing the diameter of the cell by the speed of the cell. The UE 3 may be configured to read the TAC upon expiry of the timer T_{TAC2} (or at the subsequent T_{TAC1} expiry or TAC check-up point). In other words, when T_{TAC2} is used in combination with T_{TAC1} and/or TAC check-up points, the UE 3 may ignore T_{TAC1} expiry and/or TAC check-up point until expiry of the timer T_{TAC2}. Similarly to Option 1, mobility of the UE 3 may also be used to determine whether the UE 3 should to re-read TAC information for the cell. Option 2 may be particularly beneficial for IoT devices which may not be required or able to receive a system information update notification or paging.

Option 3: The UE 3 is configured to read TAC information and perform RAU based on a location/distance-based trigger. For example, if the location of the UE 3 has changed more than a threshold since its last cell reselection/last RAU/network attachment, then RAU is triggered (after the UE 3 reading the TAC of its current cell, if appropriate). Based on the threshold and the UE's location when last performing RAU, the network is able to determine an appropriate area in which to page the UE 3 even if the UE 3 does not provide any subsequent RAU. This area is a substantially circular area with the centre of the area being the UE's location reported in its last RAU and the diameter being equal to the applicable location threshold. The network nodes (e.g. base station/AMF) may be configured to page the UE 3 in those cells that are currently covering this area. Such location/distance-based trigger may be particularly beneficial for NTN cells especially in case of moving cells or quasi-fixed cells. Thus, the location/distance-based trigger may be applied in combination with one or more additional conditions: e.g. when the UE 3 is connected to NTN, when the NTN cell is moving, when the UE 3 is moving in the same direction as the serving satellite, and/or when the UE 3 has not performed cell reselection for a while.

Option 4: In some systems, periodical RAU may be configured for the UE 3 by the core network, using an associated RAU timer. In this system 1, a cell specific RAU timer may also be used, e.g. in addition to, or instead of the RAU timer from the core network. Specifically, the access network node 5 (base station/NTN node) may configure the UEs 3 with information identifying a period for triggering RAU based on cell size, cell/satellite speed, TAC size, and/or the like. The timer may be configured via broadcast signalling. If a UE 3 is camping on a cell for which a cell-specific RAU period has been configured, the UE 3 triggers RAU based on this cell-specific RAU period. The timer may be (re) started upon cell reselection (if the selected cell is configured with a cell-specific RAU period). The UE 3 may read the TAC information in system information before sending a RAU to the network. Beneficially, by setting the cell-specific RAU period larger than the ‘period’ given by dividing the cell diameter by the cell speed, it is possible to avoid triggering TAC information acquisition and RAU before the UE 3 has left the cell's coverage. It will be appreciated that the cell-specific RAU period may be adapted for each UE 3, for example, based on their location (geographical coordinates) during the RAU procedure.

Option 5: When a UE 3 needs to be paged, the network nodes may be configured to page the UE 3 located in an area where a TAC is no longer broadcast (TAC removed in a recent system information update). As explained above, a UE 3 (e.g. idle mode, configured with DRX or eDRX) may not receive any notification or paging message indicating a TAC removal resulting in the UE 3 becoming unreachable for normal paging if their current cell is no longer associated with any of the TACs in the UE's registration area (where paging is normally attempted). However, in this system 1, the nodes of the network are configured to initially attempt or continue paging the UE 3 registered using one or more TACs in those cells where one of these TACs has been recently removed (e.g. within a time threshold smaller than or equal to the UE's associated RAU timer). It will be appreciated that paging in cells where the registered TAC has been removed may take place after a paging failure is detected in the UE's current registration area (i.e. if no paging response is received from the UE 3 via the cells associated with the TACs included in the registration area). In other words, any earlier or removed TAC may be added to a secondary (or follow-up) area for paging. It will also be appreciated that the (secondary/follow-up) tracking areas may be derived based on the (estimated) trajectory of the UE's last known cell, e.g. in case of earth moving cells, and/or any other relevant information such as the cell's TAC history (including that of neighbour cells).

Beneficially, the above options make is possible to reach a particular UE if that UE is not aware of a TAC change (and has not performed a RAU) whilst camping on an NTN cell which has entered a new tracking area. The above proposed options are applicable to those UEs in particular that are moving in the same direction as the NTN cell, and in case of soft TAC update. Even when system information update notification is not provided for a TAC change/TAC removal, UEs moving in the same direction as the satellite are able perform a RAU in a timely manner and/or may be paged in an appropriate secondary paging area, if appropriate. Moreover, unnecessary system information acquisitions and RAU procedures can be avoided or at least reduced since the network and the UEs have a more accurate understanding of the correct TAC of the UE's cell (and hence the correct registration area for paging the UE).

### <User Equipment (UE)>

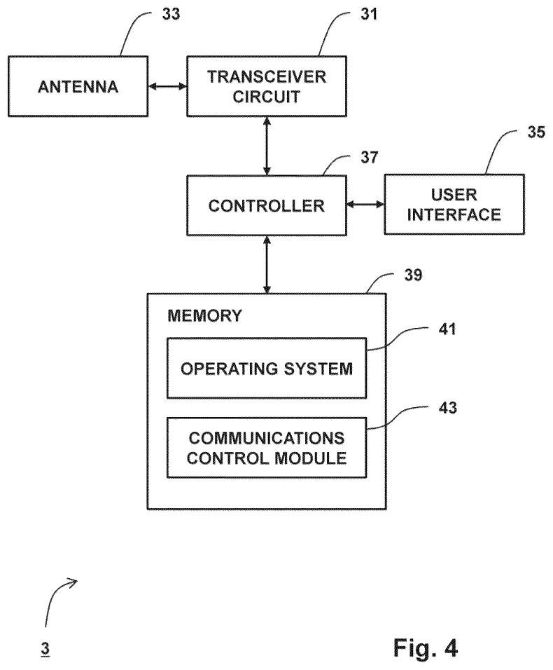

FIG. 4 is a block diagram illustrating the main components of the mobile device (UE) 3 shown in FIG. 1. As shown, the UE 3 includes a transceiver circuit 31 which is operable to transmit signals to and to receive signals from the connected node(s) via one or more antenna 33. Although not necessarily shown in FIG. 4, the UE 3 will of course have all the usual functionality of a conventional mobile device (such as a user interface 35) and this may be provided by any one or any combination of hardware, software and firmware, as appropriate. A controller 37 controls the operation of the UE 3 in accordance with software stored in a memory 39. The software may be pre-installed in the memory 39 and/or may be downloaded via the telecommunication network 1 or from a removable data storage device (RMD), for example. The software includes, among other things, an operating system 41, and a communications control module 43.

The communications control module 43 is responsible for handling (generating/sending/receiving) signalling messages and uplink/downlink data packets between the UE 3 and other nodes, including NTN nodes 5, (R)AN nodes 6, and core network nodes. The signalling may comprise control signalling related to tracking areas (TAC acquisition, registration area update, paging).

### <NTN Node (Satellite/UAS Platform)>

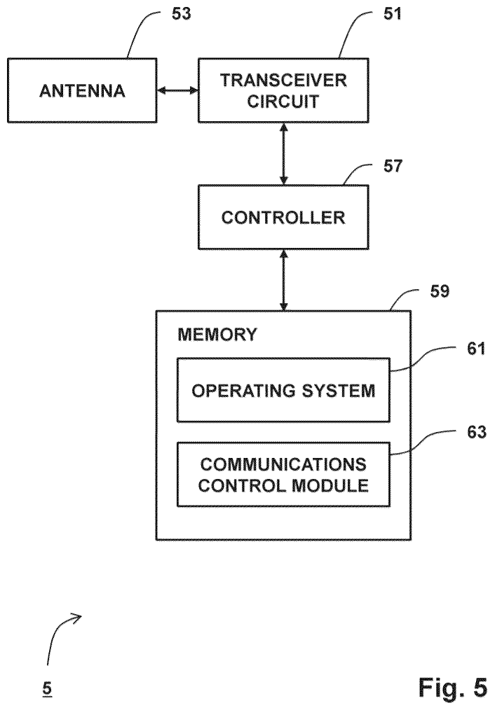

FIG. 5 is a block diagram illustrating the main components of the NTN node 5 (a satellite or a UAS platform) shown in FIG. 1. As shown, the NTN node 5 includes a transceiver circuit 51 which is operable to transmit signals to and to receive signals from connected UE(s) 3 via one or more antenna 53 and to transmit signals to and to receive signals from other network nodes such as gateways and base stations (either directly or indirectly). A controller 57 controls the operation of the NTN node 5 in accordance with software stored in a memory 59. The software may be pre-installed in the memory 59 and/or may be downloaded via the telecommunication network 1 or from a removable data storage device (RMD), for example. The software includes, among other things, an operating system 61, and a communications control module 63.

The communications control module 63 is responsible for handling (generating/sending/receiving) signalling between the NTN node 5 and other nodes, such as the UE 3, base stations 6, gateways, and core network nodes (via the base stations/gateways). The signalling may comprise control signalling related to tracking areas (TAC broadcast, registration area update, paging).

### <Base Station/Gateway (Access Network Node)>

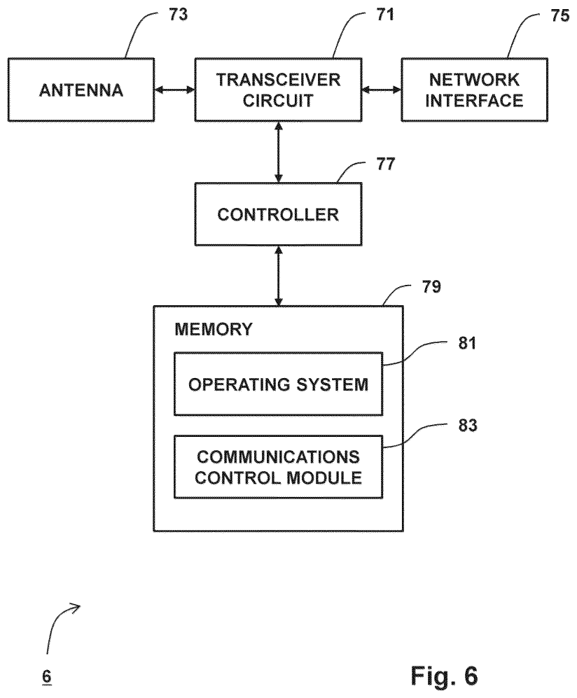

FIG. 6 is a block diagram illustrating the main components of the gateway 6 shown in FIG. 1 (a base station (gNB) or a similar access network node). As shown, the gateway/gNB 6 includes a transceiver circuit 71 which is operable to transmit signals to and to receive signals from connected UE(s) 3 via one or more antenna 73 and to transmit signals to and to receive signals from other network nodes (either directly or indirectly) via a network interface 75. Signals may be transmitted to and received from the UE(s) 3 either directly and/or via the NTN node 5, as appropriate. The network interface 75 typically includes an appropriate base station-base station interface (such as X2/Xn) and an appropriate base station-core network interface (such as S1/NG-C/NG-U). A controller 77 controls the operation of the base station 6 in accordance with software stored in a memory 79. The software may be pre-installed in the memory 79 and/or may be downloaded via the telecommunication network 1 or from a removable data storage device (RMD), for example. The software includes, among other things, an operating system 81, and a communications control module 83.

The communications control module 83 is responsible for handling (generating/sending/receiving) signalling between the base station 6 and other nodes, such as the UE 3, NTN nodes 5, and core network nodes. The signalling may comprise control signalling related to tracking areas (TAC broadcast, registration area update, paging).

### DETAILED DESCRIPTION

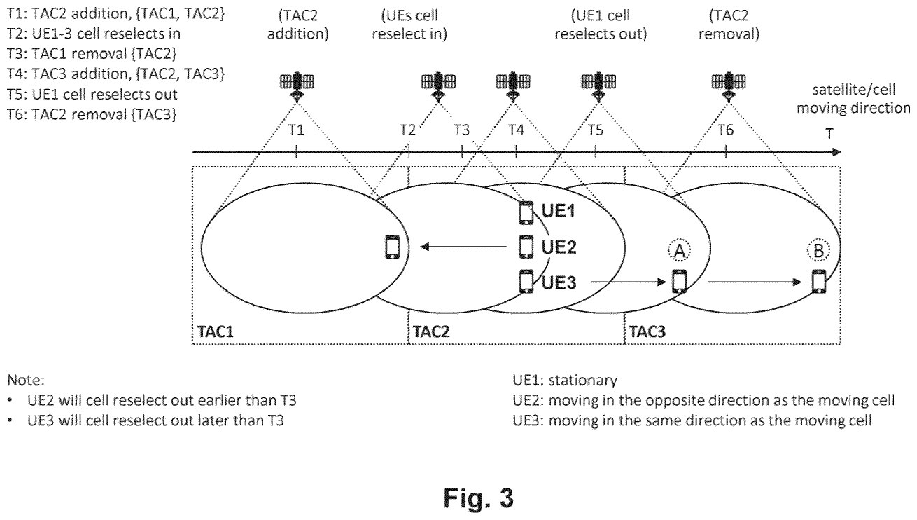

FIG. 3 illustrates an exemplary scenario in which three different UEs 3 (denoted ‘UE1’, ‘UE2’, and ‘UE3’) experience tracking area changes differently whilst camping on an NTN cell. In this example, UE1 is substantially stationary, UE2 is moving in the opposite direction to the NTN cell, and UE3 is moving in the same direction as the NTN cell.

The NTN cell has a footprint that is moving across different tracking areas. Specifically, the NTN cell is initially associated with a first tracking area denoted by ‘TAC1’, then it moves into a second tracking area (‘TAC2’), and a third tracking area (‘TAC3’). The cell employs soft TAC update. Accordingly, when the cell transitions from one tracking area to another, i.e. when the cell partially covers two (or more) tracking areas, the TACs for each covered tracking area are included in the system information.

FIG. 3 also includes a time axis (T) along with the path of the satellite which indicates some points in time at which certain actions take place. These points of time are denoted by ‘T1’ to ‘T6’, where:
T1 represents the point in time where the tracking area code (i.e. TAC2) for the second tracking area is added to the list of tracking areas broadcast in the system information for the cell. In other words, at T1 TAC2 addition occurs resulting in a set of tracking area codes {TAC1, TAC2}. As can be seen, this is the point where the edge of the cell starts to cover a geographical area (or terrestrial cell) that is associated with the second tracking area.
T2 represents the point in time where each UE (UE1 to UE 3) performs cell reselection into the NTN cell, in tracking area two. Effectively, T2 is the point where the NTN cell's footprint starts to cover the area where the UEs 3 are located. Accordingly, it will be appreciated that each UE 3 may perform an appropriate registration area update procedure using only TAC2 to register their location with the AMF/core network (if the TAC2 has not been registered with the network yet) before or after cell reselection to the cell. For simplicity, here we assume that the UEs only register to TAC2, i.e., the registration area includes only TAC2. However, in practice a registration area will include multiple TACs (e.g. TAC_{X} and TAC_{Y} in addition to TAC2).
T3 represents the point in time where TAC1 is removed from the list of tracking areas broadcast in the system information for the cell, resulting in the current set of tracking area codes {TAC2}. As can be seen, T3 is the point where the NTN cell no longer covers the geographical area (terrestrial cell) that is associated with the first tracking area (or where such coverage is limited).
T4 represents the point in time where TAC3 is added to the list of tracking areas broadcast in the system information for the cell, resulting in a set of tracking area codes {TAC2, TAC3}. T4 is the point where the edge of the cell starts to cover a geographical area (terrestrial cell) associated with the third tracking area.
T5 represents the point in time where UE1 cell reselects out of the NTN cell. In other words, at this point, the NTN cell no longer provides sufficient coverage for UE 1 (which is more or less stationary in this example). Thus, even though the NTN cell still broadcasts TAC at this point, the first UE is no longer covered by the cell.
T6 represents the point in time where TAC2 is removed from the list of tracking areas broadcast in the system information for the cell, resulting in the current set of tracking area codes {TAC3}.

The time duration of an earth moving cell swiping over a particular geographical location (e.g. where a UE 3 is located) is roughly equal to {cell diameter/cell speed}. This is the time duration all (quasi) stationary UEs 3 will stay in the cell (note: in the above example, this time duration is given by T5-T2, at least for the stationary UE1). The UEs 3 will perform cell reselection after this time duration, and they will read/update to the TAC list broadcasted by a new cell (or ‘target cell’) after cell reselection. The time duration from addition of a TAC to removal of that TAC is roughly equal to {(TAC diameter+ cell diameter)/cell speed}. Effectively, this is the time duration for which a particular tracking area/TAC will be supported by the earth moving cell.

Turning now to the non-stationary UEs (UE2 and UE3 in this example), it will be appreciated that these UEs will not perform cell reselection at the same time as the stationary UE1 since they will either leave the NTN cell's coverage earlier than UE1 (as in case of UE2) or later (as in case of UE3).

In this type of systems, the third type of UE (UE3) may experience paging problems (when moving in the same direction as the NTN cell). Specifically, when the third UE moves out of the second tracking area and into the third tracking area after T6 (see location ‘A’ in FIG. 3) whilst still within the coverage of the moving cell, then the UE3 is still registered with TAC2 (the second tracking area) which has been removed from the set of TACs broadcast for the UE's cell. At this point, the third UE is physically in the third tracking area but it has not registered TAC3 with the network if this UE is not aware of TAC3 addition and TAC2 removal (which may be the case if paging for this UE is sent based on its registered TAC, i.e. TAC2). It will be appreciated that although the second UE (UE2) is also moving, this UE will not experience such paging problems because UE2 will cell reselect out of the cell earlier than T3 (i.e. earlier than UE1) because UE2 is moving in the opposite direction to the cell.

Whilst this problem may be alleviated by triggering system information update notification upon every TAC update (removal and/or addition), this approach would result in relatively frequent system information update notifications (which may involve paging the UEs 3), and it would wake up all UEs 3 and force them to read the system information again. However, as explained above, for most UEs 3 such update is not useful most of the time because their mobility also affects which tracking area (and which TAC) shall be used for paging the UEs 3. However, in this system 1, the UEs 3 are configured to follow specific procedures to determine whether they need to acquire the updated system information and whether RAU is necessary upon system information/TAC change. Specifically, the UEs 3 are configured to employ one of the following options:

Option 1: When the UE 3 receives a system information update notification or paging message (if applicable) for TAC change/addition/removal, the UE 3 decides whether or not to acquire the updated system information (and any TAC included therein) based on specific conditions. The system information update notification or paging message may be adapted to indicate that the reason for the system information update is to provide a TAC change/addition/removal. This may be indicated using an appropriate flag or using 1-bit of information. In case that the system information update is for a TAC change/addition/removal, the UE 3 does not need to acquire the updated TACs in system information in a cell that employs soft TAC change (because soft TAC change does not remove the old TAC immediately upon adding a new TAC), especially in case of UEs 3 with low mobility, UEs 3 moving in the opposite direction as the cell moving direction, and/or UEs 3 that have performed cell reselection to this cell within a certain amount of time. Otherwise, system information acquisition may be performed, for example, if a certain amount of time has passed since the last cell reselection or last tracking area information reading by the UE 3 (determined e.g. based on an associated timer) and/or based on mobility of the UE 3 (e.g. if the UE 3 is moving in substantially the same direction as the cell: if the distance from the UE's 3 position at the last reading of the tracking area information to the UE's current location is over an associated threshold (at least in one direction): if the distance from a centre of the cell footprint is over an associated threshold (at least in one direction); and/or if the speed of the UE 3 is higher than an associated threshold). Option 2: The UE 3 is configured to read TAC information automatically when certain conditions are met (regardless whether the UE 3 has received any system information update notification or paging message). In a first possibility, the UE 3 may receive (e.g. in system information) information identifying an appropriate timer (herein referred to as ‘timer T_{TAC1}’) or information identifying one or more points in time (herein referred to as ‘TAC check-up points’) for determining whether the UE 3 should read the TAC of its cell. For example, the UE 3 may be configured to read the TAC upon expiry of the time T_{TAC1} and/or upon reaching one of the check-up points associated with its cell. It will be appreciated that the system information/TAC acquisition may be dependent on cell specific factors as well, such as the diameter of the cell and/or the speed of the cell. Effectively, a time value (for an additional timer e.g. T_{TAC2}) may be derived by dividing the diameter of the cell by the speed of the cell. The UE 3 may be configured to read the TAC upon expiry of the timer T_{TAC2} (or at the subsequent T_{TAC1} expiry or TAC check-up point). In other words, when T_{TAC2} is used in combination with T_{TAC1} and/or TAC check-up points, the UE 3 may ignore T_{TAC1} expiry and/or TAC check-up point until expiry of the timer T_{TAC2}. Similarly to Option 1, mobility of the UE 3 may also be used to determine whether the UE 3 should to re-read TAC information for the cell. Option 2 may be particularly beneficial for IoT devices which may not be required or able to receive a system information update notification or paging.

Option 3: The UE 3 is configured to read TAC information and perform RAU based on a location/distance-based trigger. For example, if the location of the UE 3 has changed more than a threshold since its last cell reselection/last RAU/network attachment, then RAU is triggered (after the UE 3 reading the TAC of its current cell, if appropriate). Based on the threshold and the UE's location when last performing RAU, the network is able to determine an appropriate area in which to page the UE 3 even if the UE 3 does not provide any subsequent RAU. This area is a substantially circular area with the centre of the area being the UE's location reported in its last RAU and the diameter being equal to the applicable location threshold. The network nodes (e.g. base station/AMF) may be configured to page the UE 3 in those cells that are currently covering this area. Such location/distance-based trigger may be particularly beneficial for NTN cells especially in case of moving cells or quasi-fixed cells. Thus, the location/distance-based trigger may be applied in combination with one or more additional conditions: e.g. when the UE 3 is connected to NTN, when the NTN cell is moving, when the UE 3 is moving in the same direction as the serving satellite, and/or when the UE 3 has not performed cell reselection for a while.

Option 4: In some systems, periodical RAU may be configured for the UE 3 by the core network, using an associated RAU timer. In this system 1, a cell specific RAU timer may also be used, e.g. in addition to, or instead of the RAU timer from the core network. Specifically, the access network node 5 (base station/NTN node) may configure the UEs 3 with information identifying a period for triggering RAU based on cell size, cell/satellite speed, TAC size, and/or the like. The timer may be configured via broadcast signalling. If a UE 3 is camping on a cell for which a cell-specific RAU period has been configured, the UE 3 triggers RAU based on this cell-specific RAU period. The timer may be (re) started upon cell reselection (if the selected cell is configured with a cell-specific RAU period). The UE 3 may read the TAC information in system information before sending a RAU to the network. Beneficially, by setting the cell-specific RAU period larger than the ‘period’ given by dividing the cell diameter by the cell speed, it is possible to avoid triggering TAC information acquisition and RAU before the UE 3 has left the cell's coverage. It will be appreciated that the cell-specific RAU period may be adapted for each UE 3, for example, based on their location (geographical coordinates) during the RAU procedure.

Alternatively, the network nodes (e.g. AMF) may be configured to maintain information regarding the UE's current location (on tracking area level) even when the UE does not report its tracking area after the UE's last know cell (NTN cell) has changed its TAC information. This approach is referred to as ‘option 5’: Option 5: When a UE 3 needs to be paged, the network nodes may be configured to page the UE 3 in an area where a TAC in UE registration area is no longer broadcast (TAC removed in a recent system information update). As explained above, a UE 3 (e.g. idle mode, configured with DRX or eDRX) may not receive any notification or paging message indicating a TAC removal resulting in the UE 3 becoming unreachable for normal paging if their current cell is no longer associated with any of the TACs in the UE's registration area (where paging is normally attempted). However, in this system 1, the nodes of the network are configured to initially attempt or continue paging the UE 3 registered using one or more TACs in those cells where one of these TACs has been recently removed (e.g. within a time threshold smaller than or equal to the UE's associated RAU timer). It will be appreciated that paging in cells where the registered TAC has been removed may take place after a paging failure is detected in the UE's current registration area (i.e. if no paging response is received from the UE 3 via the cells associated with the TACs included in the registration area). In other words, any earlier or removed TAC may be added to a secondary (or follow-up) area for paging. It will also be appreciated that the (secondary/follow-up) tracking areas may be derived based on the (estimated) trajectory of the UE's last known cell, e.g. in case of earth moving cells, and/or any other relevant information such as the cell's TAC history (including that of neighbour cells).

Beneficially, the above options make is possible to reach a particular UE if that UE is not aware of a (soft) TAC change (and has not performed a RAU) whilst camping on an NTN cell which has entered a new tracking area. The above proposed options are applicable to those UEs in particular that are moving in the same direction as the NTN cell, and in case of hard TAC change. Even when system information update notification is not provided for a TAC change/TAC removal, UEs moving in the same direction as the satellite are able perform a TAU in a timely manner and/or may be paged in an appropriate secondary paging area, if appropriate. Moreover, unnecessary system information acquisitions and TAU procedures can be avoided or at least reduced since the network and the UEs have a more accurate understanding of the correct TAC of the UE's cell (and hence the correct tracking area for paging the UE).

The following is a description of some exemplary information that may be used to realise one or more of these options.

### <Tac Configuration>

TAC configuration may be provided for a cell using the system information block type 1 (SIB1), in Radio Resource Control (RRC) signalling. The SIB1 may include the ‘CellAccessRelatedInfo’ information element which includes the ‘plmn-Identity List’ field for providing the applicable TAC configuration for a given cell:

CellAccessRelatedInfo ::= SEQUENCE {

| plmn-IdentityList | PLMN-IdentityInfoList, | |
|---|---|---|
| cellReservedForOtherUse | ENUMERATED {true} | OPTIONAL, |
| | | -- Need R |

```
  ...,
  [[
```

| | | |
|---|---|---|
| cellReservedForFutureUse-r16 | ENUMERATED {true} | OPTIONAL, |
| | | -- Need R |
| npn-IdentityInfoList-r16 | NPN-IdentityInfoList-r16 | OPTIONAL |
| | | -- Need R |

]]
}

In this example, the ‘plmn-Identity List’ field is used to configure a set of ‘PLMN-IdentityInfo’ elements. Each of those elements contains a list of one or more PLMN Identities and additional information associated with those PLMNs. A PLMN-identity can be included only once, and in only one entry of the ‘PLMN-Identity InfoList’ field. The PLMN index is defined using the formula b1+b2+ . . . +b (n−1)+i for the PLMN included at the n-th entry of the ‘PLMN-IdentityInfoList’ field and the i-th entry of its corresponding ‘PLMN-Identity Info’, where b (j) is the number of ‘PLMN-Identity’ entries in each ‘PLMN-IdentityInfo’, respectively.

Further details of the ‘plmn-IdentityList’ field are shown below:

| | |
|---|---|
| PLMN-IdentityInfoList ::= | SEQUENCE (SIZE (1..maxPLMN)) OF |

PLMN-IdentityInfo

| | |
|---|---|
| PLMN-IdentityInfo ::= | SEQUENCE { |
| plmn-IdentityList | SEQUENCE (SIZE (1..maxPLMN)) OF |

PLMN-Identity,

| | | |
|---|---|---|
| trackingAreaCode | TrackingAreaCode | OPTIONAL, -- Need R |
| ranac | RAN-AreaCode | OPTIONAL, -- Need R |

| | |
|---|---|
| cellIdentity | CellIdentity, |

| | |
|---|---|
| cellReservedForOperatorUse | ENUMERATED {reserved, notReserved}, |

```
  ...,
  [[
```

| | | |
|---|---|---|
| iab-Support-r16 | ENUMERATED {true} | OPTIONAL -- Need S |

In this example, the ‘trackingAreaCode’ field indicates the Tracking Area Code to which the cell indicated by the ‘cellIdentity’ field belongs. The absence of the field indicates that the cell only supports PSCell/SCell functionality (per PLMN).

With soft TAC change scheme, the ‘tracking AreaCode’ will be extended to include a list of ‘trackingAreaCode(s)’, to support multiple TACs per PLMN. While the cell is in use, the ‘tracking AreaCode’ list may be updated to add, remove or change one or multiple tracking area code(s) to reflect the currently associated tracking areas for that cell. The UEs are configured to obtain the tracking area identifier list associated with the cell from the above shown TAC configuration fields.

### <Short Message>

Short Messages can be transmitted on the Physical Downlink Control Channel (PDCCH) using a Paging Radio Network Temporary Identifier (P-RNTI) with or without associated Paging message using Short Message field in DCI format 1_0 (see 3GPP TS 38.212, clause 7.3.1.2.1).

Table 6.5-1 of 3GPP TS 38.331 defines Short Messages that may be used for indicating system information modification. Bit 1 is the most significant bit. Bit 4-8 have not been used yet and it will appreciated that one of these bits may be adapted to indicate if TAC information has changed (or it is going to be changed) in system information.

| Bit | Short Message |
|---|---|
| 1 | systeminfoModification |
| | If set to 1: indication of a Broadcast Control Channel (BCCH) modification other |
| | than SIB6, SIB7 and SIB8. |
| 2 | etwsAndCmasindication |
| | If set to 1: indication of an Earthquake and Tsunami Warning System (ETWS) |
| | primary notification and/or an ETWS secondary notification and/or a |
| | Commercial Mobile Alert System (CMAS) notification. |
| 3 | stopPagingMonitoring |
| | This bit can be used for only operation with shared spectrum channel access |
| | and if nrofPDCCH-MonitoringOccasionPerSSB-InPO is present. |
| | If set to 1: indication that the UE may stop monitoring PDCCH occasion(s) for |
| | paging in this Paging Occasion as specified in 3GPP TS 38.304, clause 7.1. |
| 4-8 | Not used in the current 3GPP release. At least one bit may be adapted to |
| | indicate if TAC information has changed (or it is about to change) in the system |
| | information. |

### Modifications and Alternatives

Detailed example embodiments have been described above. As those skilled in the art will appreciate, a number of modifications and alternatives can be made to the above example embodiments whilst still benefiting from the inventions embodied therein. By way of illustration only a number of these alternatives and modifications will now be described.

It will be appreciated that the above example embodiments may be applied to both 5G New Radio and LTE systems (E-UTRAN). A base station (gateway) that supports E-UTRA/4G protocols may be referred to as an ‘eNB’ and a base station that supports NextGeneration/5G protocols may be referred to as a ‘gNBs’. It will be appreciated that some base stations may be configured to support both 4G and 5G protocols, and/or any other 3GPP or non-3GPP communication protocols.

LEO satellites may have steerable beams in which case the beams are temporarily directed to substantially fixed footprints on the Earth. In other words, the beam footprints (which represent respective NTN cells) are stationary on the ground for a certain amount of time before they change their focus area over to another NTN cell (due to the satellite's movement on its orbit). From cell coverage/UE point of view, this results in cell changes happening regularly at discrete intervals, even when the beams serve the same land area (have the same footprint) because different beams appear as different cells to the UEs (due to using different PCIs and/or Synchronization Signal/Physical Broadcast Channel blocks (SSBs) after each service link change). LEO satellites without steerable beams cause the beams (cells) moving on the ground constantly in a sweeping motion as the satellite moves along its orbit and as in the case of steerable beams, service link change and consequently cell changes happen regularly at discrete intervals. It will be appreciated that a TAC change may occur due to such service link changes regardless of whether steerable beams are used or not.

Similarly to service link changes, feeder link changes also happen at regular intervals due to the satellite's movement on its orbit. Both service and feeder link changes may be performed between different base stations/gateways (which may be referred to as an ‘inter-gNB radio link switch’) or within the same base station/gateway (‘intra-gNB radio link switch’). It will be appreciated that a TAC change may occur due to such feeder link changes. Therefore, the above described methods may be performed at service and/or feeder link changes, if appropriate.

It will be appreciated that the above described paging message for notifying UEs about a system information change may comprise an appropriately formatted short message transmitted in a downlink control information (DCI).

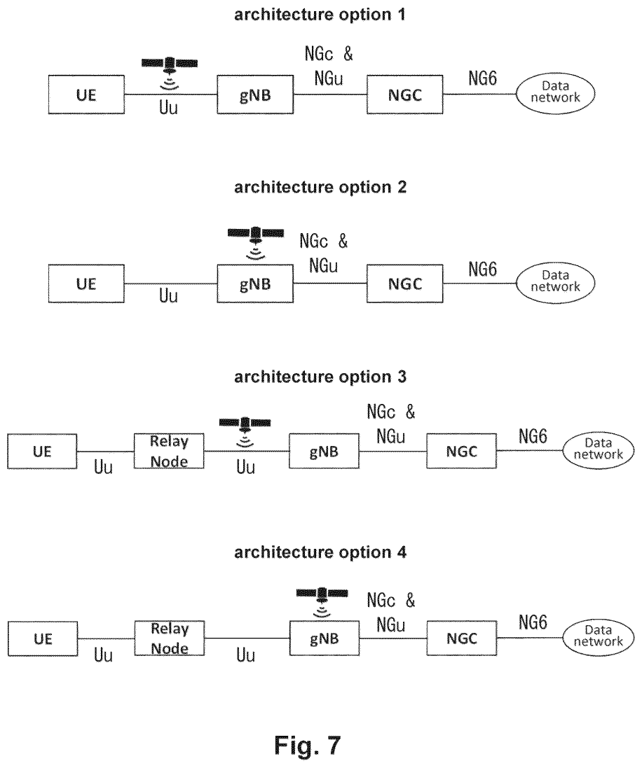

It will be appreciated that there are various architecture options to implement NTN in a 5G system, some of which are illustrated schematically in FIG. 7. The first option shown is an NTN featuring an access network serving UEs and based on a satellite/aerial with bent pipe payload and gNB on the ground (satellite hub or gateway level). The second option is an NTN featuring an access network serving UEs and based on a satellite/aerial with gNB on board. The third option is an NTN featuring an access network serving Relay Nodes and based on a satellite/aerial with bent pipe payload. The fourth option is an NTN featuring an access network serving Relay Nodes and based on a satellite/aerial with gNB. It will be appreciated that other architecture options may also be used, for example, a combination of two or more of the above described options. Alternatively, the relay node may comprise a satellite/UAS.

TABLE 1
types of satellites and UAS platforms

| | | | | Typical beam | |
|---|---|---|---|---|---|
| Platforms | Altitude range | | Orbit | footprint size | |
| Low-Earth Orbit | 300-1500 | km | Circular around the | 100-1000 | km |
| (LEO) satellite | | | earth | | |
| Medium-Earth Orbit | 7000-25000 | km | | 100-1000 | km |
| (MEO) satellite | | | | | |
| Geostationary Earth | 35 786 | km | Notional station keeping | 200-3500 | km |
| Orbit (GEO) satellite | | | position fixed in terms | | |
| UAS platform | 8-50 km | | of elevation/azimuth | 5-200 | km |
| (including HAPS) | (20 km for HAPS) | | with respect to a given | | |
| | | | earth point | | |
| High Elliptical Orbit | 400-50000 | km | Elliptical around the | 200-3500 | km |
| (HEO) satellite | | | earth | | |

In the above description, the UE, the NTN node (satellite/UAS platform), and the access network node (base station) are described for ease of understanding as having a number of discrete modules (such as the communication control modules). Whilst these modules may be provided in this way for certain applications, for example where an existing system has been modified to implement the present disclosure, in other applications, for example in systems designed with the inventive features in mind from the outset, these modules may be built into the overall operating system or code and so these modules may not be discernible as discrete entities. These modules may also be implemented in software, hardware, firmware or a mix of these.

Each controller may comprise any suitable form of processing circuitry including (but not limited to), for example: one or more hardware implemented computer processors: microprocessors: central processing units (CPUs); arithmetic logic units (ALUs): input/output (IO) circuits; internal memories/caches (program and/or data): processing registers: communication buses (e.g. control, data and/or address buses); direct memory access (DMA) functions; hardware or software implemented counters, pointers and/or timers; and/or the like.

In the above example embodiments, a number of software modules were described. As those skilled in the art will appreciate, the software modules may be provided in compiled or un-compiled form and may be supplied to the UE, the NTN node, and the access network node (base station) as a signal over a computer network, or on a recording medium. Further, the functionality performed by part or all of this software may be performed using one or more dedicated hardware circuits. However, the use of software modules is preferred as it facilitates the updating of the UE, the NTN node, and the access network node (base station) in order to update their functionalities.

The above example embodiments are also applicable to ‘non-mobile’ or generally stationary user equipment. The above described mobile device may comprise an MTC/IoT device and/or the like.

The indication that a change of tracking area identifiers has occurred may include at least one bit or a flag indicating that system information associated with the cell has been updated to change at least one tracking area identifier.

In a case where the determining is based on the mobility parameter associated with the UE, the mobility parameter may include at least one of: a parameter identifying whether the UE is substantially stationary or substantially mobile: a parameter identifying a distance travelled by the UE since the UE obtained the first tracking area identifier list from the system information; and a parameter identifying a direction of the UE relative to a direction associated with the cell. The method performed by the UE may further comprise at least one of: obtaining the tracking area identifier list in a case where the determining determines, based on the mobility parameter, that the UE is moving in substantially the same direction as the cell; and obtaining the tracking area identifier list in a case where the determining determines, based on the time parameter, that the time elapsed since the UE obtained the tracking area identifier list from the system information or since the UE reselected to the cell is greater than an associated threshold.

The method performed by the UE may further comprise configuring the UE to not obtain the information indicating that the tracking area identifier associated with the cell has changed or to not monitor for the current tracking area identifier associated with the cell until the time elapsed since reselecting to the cell is greater than the time threshold.

The time threshold may be given by dividing a number representing the diameter associated with the cell/a typical tracking area by a number representing the speed associated with the cell.

The time parameter may identify a time period between consecutive time points for obtaining the tracking area identifier list for the cell.

The obtaining the tracking area identifier list by the UE may comprise obtaining the tracking area identifier list based on at least one mobility parameter associated with the UE.

The cell specific period may be determined based on at least one of: a size associated with the cell: a speed associated with the cell: a travel direction associated with the cell; and a number of tracking areas associated with the cell.

The method performed by the UE may further comprise starting a timer corresponding to the cell specific period upon selecting the cell.

The method performed by the UE may further comprise obtaining a tracking area identifier list broadcast in the cell before triggering the registration area update procedure.

The method performed by the network node may further comprise determining that the first tracking area identifier has been removed from the tracking area identifier list based on information relating to a trajectory of the first cell.

The method performed by the network node may further comprise determining that the UE has not responded to a preceding paging message in any other cell before transmitting the paging message towards the UE via the first cell.

While the present disclosure has been particularly shown and described with reference to example embodiments thereof, the present disclosure is not limited to these embodiments. It will be understood by those of ordinary skill in the art that various changes in form and details may be made therein without departing from the spirit and scope of the present disclosure as defined by the claims. Various other modifications will be apparent to those skilled in the art and will not be described in further detail here.

For example, all or some of the embodiments disclosed above can be described like in, but not limited to, the following supplementary notes.

### (Supplementary Note 1)

A method performed by a user equipment (UE), the method comprising:
receiving a tracking area identifier list associated with a current cell of the UE based on a time parameter related to at least one of:
   a time point for determining a time for receiving the tracking area identifier list;
   a cell specific period;
   a time elapsed since the UE received the tracking area identifier list from system information: or
   a time elapsed since the UE reselected to the current cell, wherein the tracking area identifier list includes at least one tracking area identifier.

### (Supplementary Note 2)

The method according to Supplementary Note 1, further comprising:
receiving an indication that a change of tracking area identifiers has occurred with respect to the current cell; and
determining whether to receive the tracking area identifier list based on the indication and the time parameter.

### (Supplementary Note 3)

The method according to Supplementary Note 2, wherein the indication includes at least one bit or a flag indicating that system information associated with the cell has been updated to change at least one tracking area identifier.

### (Supplementary Note 4)

The method according to Supplementary Note 1, wherein
the time parameter includes information identifying a time threshold relating to the current cell; and
the receiving is performed in a case that a time elapsed since the UE received the tracking area identifier list is greater than the time threshold.

### (Supplementary Note 5)

The method according to Supplementary Note 4, further comprising configuring the UE to:
not receive the information indicating that the tracking area identifier associated with the current cell has changed or not monitor for the current tracking area identifier associated with the current cell until the time elapsed since reselecting to the current cell is greater than the time threshold.

### (Supplementary Note 6)

The method according to Supplementary Note 4 or 5, wherein the time threshold is given by dividing a number representing the diameter associated with the current cell or a typical tracking area by a number representing the speed associated with the current cell.

### (Supplementary Note 7)

The method according to Supplementary Note 1, wherein the time parameter identifies a time period between consecutive time points for receiving the tracking area identifier list.

### (Supplementary Note 8)

The method according to Supplementary Note 1, wherein
the time parameter is related to the cell specific period, and
the method comprises triggering registration area update procedure, in the current cell, based on the cell specific period.

### (Supplementary Note 9)

The method according to Supplementary Note 8, wherein the cell specific period is determined based on at least one of:
a size associated with the current cell;
a speed associated with the current cell;
a travel direction associated with the current cell: or
a number of tracking areas associated with the current cell.

### (Supplementary Note 10)

The method according to Supplementary Note 8 or 9, further comprising starting a timer corresponding to the cell specific period upon selecting the current cell.

### (Supplementary Note 11)

The method according to any one of Supplementary Notes 8 to 10, wherein the receiving the tracking area identifier list broadcast in the current cell is performed before the triggering the registration area update procedure.

### (Supplementary Note 12)

A method performed by a user equipment (UE), the method comprising:
registering a tracking area identifier list with a network node based on at least one condition;
wherein the at least one condition includes one or more of:
   a condition that a current cell of the UE is a non-terrestrial cell;
   a condition that the current cell is an earth-moving cell;
   a condition that the UE is moving in substantially the same direction as the current cell;
   a condition that the current cell is configurable to associate with a plurality of tracking areas;
   a condition that a distance travelled by the UE since the registering the first identifier with the network node is greater than an associated distance threshold; or
   a condition that a time elapsed since the registering the first identifier with the network node is greater than an associated time threshold.

### (Supplementary Note 13)

A method performed by an access network node, the method comprising:
transmitting a tracking area identifier list associated with a cell of the access network node, wherein the tracking area identifier list includes at least one tracking area identifier;
updating the tracking area list wherein the updating includes at least one of: tracking area identifier addition;
   tracking area identifier removal: or
   tracking area identifier change:
concerning the at least one tracking area identifier; and
transmitting an indication that the tracking area identifier list has been updated;
wherein the indication is adapted to be used in determining, by a user equipment (UE), whether to receive the tracking area identifier list, and
the determining is based on a time parameter related to at least one of:
   a time point for determining a time for receiving the tracking area identifier list;
   a cell specific period;
   a time elapsed since the UE received the tracking area identifier list from system information: or
   a time elapsed since the UE reselected to the cell.

### (Supplementary Note 14)

A method performed by a network node for handling connection and mobility management for a user equipment (UE), the method comprising:
maintaining a registration area associated with the UE, the registration area including a set of tracking area identifiers for use in transmitting a paging message for the UE, the set including a first tracking area identifier; and
transmitting, via a first cell, a paging message towards the UE in a case that the first tracking area identifier has been removed from a tracking area identifier list associated with the first cell.

### (Supplementary Note 15)

The method according to Supplementary Note 14, further comprising determining that the first tracking area identifier has been removed from the tracking area identifier list based on information relating to a trajectory of the first cell.

### (Supplementary Note 16)

The method according to Supplementary Note 14 or 15, further comprising determining that the UE has not responded to a preceding paging message in any other cell before transmitting the paging message towards the UE via the first cell.

(Supplementary Note 17) A user equipment (UE) comprising:
means for receiving a tracking area identifier list associated with a current cell of the UE based on a time parameter related to at least one of:
a time point for determining a time for receiving the tracking area identifier list:

a cell specific period:

a time elapsed since the UE received the tracking area identifier list from system information: or
a time elapsed since the UE reselected to the current cell.

### (Supplementary Note 18)

The UE according to Supplementary Note 17, further comprising:
means for receiving an indication that a change of tracking area identifiers has occurred with respect to the current cell; and
means for determining whether to receive the tracking area identifier list based on the indication and the time parameter.

### (Supplementary Note 19)

The UE according to Supplementary Note 17, wherein
the time parameter includes information identifying a time threshold relating to the current cell; and
the means for receiving is configured to receive the tracking area identifier list in a case that a time elapsed since the UE received the tracking area identifier list is greater than the time threshold.

### (Supplementary Note 20)

The UE according to Supplementary Note 17, wherein
the time parameter is related to the cell specific period, and the UE further comprises:
means for triggering registration area update procedure, in the current cell, based on the cell specific period.

### (Supplementary Note 21)

A user equipment (UE) comprising:
means for registering a tracking area identifier list with a network node based on at least one condition;
wherein the at least one condition includes one or more of:
   a condition that a current cell of the UE is a non-terrestrial cell;
   a condition that the current cell is an earth-moving cell:
   a condition that the UE is moving in substantially the same direction as the current cell;
   a condition that the current cell is configurable to associate with a plurality of tracking areas;
   a condition that a distance travelled by the UE since the registering the first identifier with the network node is greater than an associated distance threshold; or
   a condition that a time elapsed since the registering the first identifier with the network node is greater than an associated time threshold.

### (Supplementary Note 22)

An access network node comprising:
means for transmitting a tracking area identifier list associated with a cell of the access network node, wherein the tracking area identifier list includes at least one tracking area identifier;
means for updating the tracking area list wherein the updating includes at least one of:
   tracking area identifier addition;
   tracking area identifier removal: or
   tracking area identifier change:
concerning the at least one tracking area identifier; and
means for transmitting an indication that the tracking area identifier list has been updated;
wherein the indication is adapted to be used in determining, by a user equipment (UE), whether to receive the tracking area identifier list, and
the determining is based on a time parameter related to at least one of:
   a time point for determining a time for receiving the tracking area identifier list;
   a cell specific period;
   a time elapsed since the UE received the tracking area identifier list from system information: or
   a time elapsed since the UE reselected to the cell.

### (Supplementary Note 23)

A network node for handling connection and mobility management for a user equipment (UE), the network node comprising:
means for maintaining a registration area associated with the UE, the registration area including a set of tracking area identifiers for use in transmitting a paging message for the UE, the set including a first tracking area identifier; and
means for transmitting, via a first cell, a paging message towards the UE in a case that the first tracking area identifier has been removed from a tracking area identifier list associated with the first cell.

This application is based upon and claims the benefit of priority from United Kingdom Patent Application No. 2118814.9, filed on Dec. 22, 2021, the disclosure of which is incorporated herein in its entirety by reference.

### REFERENCE SIGNS LIST

3 UE
5 SATELLITE
6 BASE STATION
7 DATA NETWORK

What is claimed is:

1. A method performed by a user equipment (UE), the method comprising:
receiving, from an access network node, a tracking area identifier list associated with a current cell of the UE based on a time parameter related to a time elapsed since the UE selected to the current cell, wherein the tracking area identifier list includes at least one tracking area identifier.

2. The method according to claim 1, further comprising:
receiving an indication that a change of tracking area identifiers has occurred with respect to the current cell; and
determining whether to receive the tracking area identifier list based on the indication and the time parameter.

3. The method according to claim 2, wherein
the indication includes at least one bit or a flag indicating that system information associated with the cell has been updated to change at least one tracking area identifier.

4.-6. (canceled)

7. The method according to claim 1, wherein the time parameter identifies a time period between consecutive time points for receiving the tracking area identifier list.

8. The method according to claim 1, wherein
the time parameter is related to a cell specific period, and
the method comprises triggering registration area update procedure, in the current cell, based on the cell specific period.

9. The method according to claim 8, wherein the cell specific period is determined based on at least one of:
a size associated with the current cell;
a speed associated with the current cell;
a travel direction associated with the current cell; or
a number of tracking areas associated with the current cell.

10. The method according to claim 8, further comprising:
starting a timer corresponding to the cell specific period upon selecting the current cell.

11. The method according to claim 8, wherein
the receiving the tracking area identifier list broadcast in the current cell is performed before the triggering the registration area update procedure.

12. (canceled)

13. A method performed by an access network node, the method comprising:
transmitting a tracking area identifier list associated with a cell of the access network node, wherein the tracking area identifier list includes at least one tracking area identifier;
updating the tracking area list concerning the at least one tracking area identifier; and
transmitting an indication that the tracking area identifier list has been updated;
wherein the indication includes a time parameter related to a time elapsed since the UE selected to the cell.

14.-16. (canceled)

17. A user equipment (UE) comprising:
at least one memory storing instructions; and
at least one processor configured to process the instructions to:
receive, from an access network node, a tracking area identifier list associated with a current cell of the UE based on a time parameter related to a time elapsed since the UE selected to the current cell.

18. The UE according to claim 17, wherein the at least one processor is configured to process the instructions to:
receive an indication that a change of tracking area identifiers has occurred with respect to the current cell; and
determine whether to receive the tracking area identifier list based on the indication and the time parameter.

19. (canceled)

20. The UE according to claim 17, wherein
the time parameter is related to a cell specific period, and
the at least one processor is configured to trigger registration area update procedure, in the current cell, based on the cell specific period.

21. (canceled)

22. An access network node comprising:
at least one memory storing instructions; and
at least one processor configured to process the instructions to:
transmit a tracking area identifier list associated with a cell of the access network node, wherein the tracking area identifier list includes at least one tracking area identifier;
update the tracking area list concerning the at least one tracking area identifier; and
transmit for transmitting an indication that the tracking area identifier list has been updated;
wherein the indication includes a time parameter related to a time elapsed since the UE selected to the cell.

23. (canceled)
